(19) United States
(12) Patent Application Publication
(10) Pub. No.: US 2022/0122799 A1
(43) Pub. Date: Apr. 21, 2022

(54) FUSE WITH ARC QUENCHING SILICONE COMPOSITION

(71) Applicant: Littelfuse, Inc., Chicago, IL (US)

(72) Inventors: Chun-Kwan Tsang, MORGAN HILL, CA (US); Todd Dietsch, Chicago, IL (US)

(73) Assignee: Littelfuse, Inc., Chicago, IL (US)

(21) Appl. No.: 17/459,098

(22) Filed: Aug. 27, 2021

Related U.S. Application Data
(60) Provisional application No. 63/092,075, filed on Oct. 15, 2020.

(51) Int. Cl. H01H 85/055; H01H 85/165; H01H 69/02

(52) U.S. Cl. CPC H01H 85/055; H01H 69/02; H01H 85/165

(57) ABSTRACT

A fuse including an electrically insulating, tubular fuse body, electrically conductive first and second endcaps disposed over opposing ends of the fuse body, a fusible element extending through the fuse body and connecting the first endcap to the second endcap, the fusible element having a central portion adapted to melt and separate upon an overcurrent condition in the fuse, and first and second arc barriers disposed on the fusible element on opposing sides of the central portion, the first and second arc barriers formed of a silicone composition that includes an arc quenching filler suspended in a silicone resin.

### CROSS-REFERENCES TO RELATED APPLICATIONS

This application claims the benefit of U.S. Provisional Patent Application No. 63/092,075, filed Oct. 15, 2020, which is incorporated by reference herein in its entirety

### BACKGROUND

### Field

The present disclosure relates generally to the field of circuit protection devices. More specifically, the present disclosure relates to a fuse with arc barriers formed of an arc quenching silicone composition.

### Description of Related Art

Fuses are commonly used as circuit protection devices and are typically installed between a source of electrical power and a component in an electrical circuit that is to be protected. A conventional fuse includes a fusible element disposed within a hollow, electrically insulating fuse body. Upon the occurrence of a fault condition, such as an overcurrent condition, the fusible element melts or otherwise separates to interrupt the flow of electrical current through the fuse.

When the fusible element of a fuse separates as a result of an overcurrent condition, it is sometimes possible for an electrical arc to propagate between the separated portions of the fusible element (e.g., through residual, vaporized particulate between the separated portions of the fusible element). If not extinguished, the electrical arc may allow significant follow-on currents to flow to from a source of electrical power to a protected component in a circuit, resulting in damage to the protected component despite the physical opening of the fusible element. Moreover, heat generated by an electrical arc can burn and/or rupture the fuse body of a fuse, potentially causing damage to surrounding components. It is therefore desirable to extinguish an electrical arc as quickly as possible to prevent or mitigate any damage to connected and surrounding components that might result therefrom.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A fuse in accordance with a non-limiting embodiment of the present disclosure may include an electrically insulating, tubular fuse body, electrically conductive first and second endcaps disposed over opposing ends of the fuse body, a fusible element extending through the fuse body and connecting the first endcap to the second endcap, the fusible element having a central portion adapted to melt and separate upon an overcurrent condition in the fuse, and first and second arc barriers disposed on the fusible element on opposing sides of the central portion, the first and second arc barriers formed of a silicone composition that includes an arc quenching filler suspended in a silicone resin.

A method of producing and dispensing an arc quenching silicone composition in accordance with the present disclosure may include adding an arc quenching filler to a silicone resin in a liquid state, mixing the arc quenching filler and the silicone resin to create a homogeneous composition, dispensing the composition onto a fusible element of a fuse, and curing the composition.

### BRIEF DESCRIPTION OF THE DRAWINGS

FIG. 1A is a cross-sectional side view illustrating a fuse in accordance with an exemplary embodiment of the present disclosure in a normal operating condition;

FIG. 1B is a cross-sectional side view illustrating the fuse of FIG. 1B upon the occurrence of an overcurrent condition;

FIG. 2 is a flow diagram illustrating an exemplary method for mixing and dispensing an arc quenching silicone composition in accordance with the present disclosure.

### DETAILED DESCRIPTION

An exemplary embodiment of a fuse having arc barriers formed of an arc quenching silicone composition in accordance with the present disclosure will now be described more fully hereinafter with reference to the accompanying drawings. The fuse may, however, be embodied in many different forms and should not be construed as being limited to the embodiments set forth herein. Rather, these embodiments are provided so that this disclosure will convey certain exemplary aspects of the fuse to those skilled in the art.

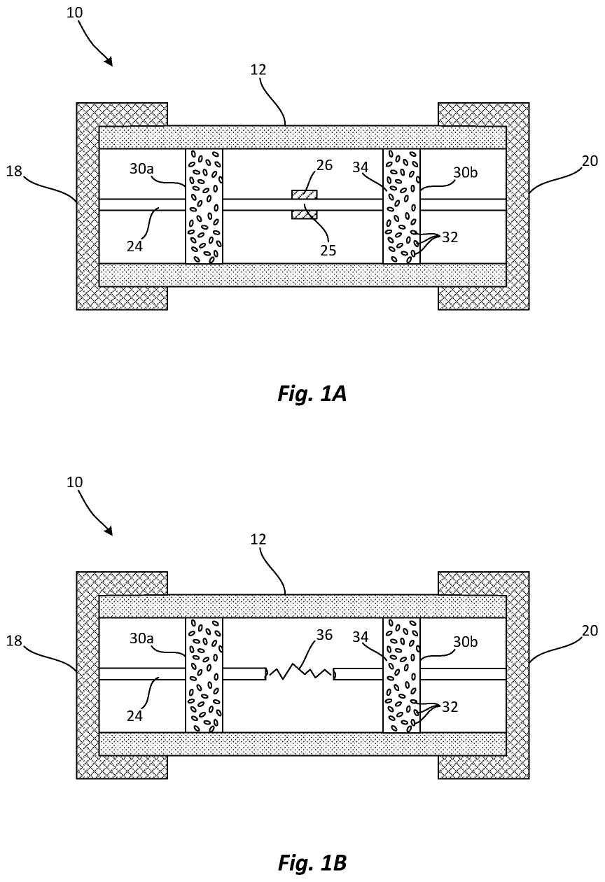

Referring to FIG. 1A, a cross sectional side view illustrating a fuse having arc barriers formed of an arc quenching silicone composition (hereinafter “the fuse 10”) in accordance with an exemplary embodiment of the present disclosure is shown. In various embodiments, the fuse 10 may be a cartridge fuse having a tubular fuse body 12. The present disclosure is not limited in this regard. In various alternative embodiments, the fuse 10 may be a surface mount fuse or other type of fuse having a fusible element extending through a generally hollow fuse body. The fuse body 12 may be formed of an electrically insulating and preferably heat resistant material. Examples of such materials include, but are not limited to, ceramic and glass.

A pair of electrically conductive endcaps 18, 20 may be disposed on opposing ends of the fuse body 12 and may be adapted to facilitate electrical connection of the fuse 10 within a circuit. A fusible element 24 may extend through the hollow interior of the fuse body 12 and may be connected to the endcaps 18, 20 in electrical communication therewith, such as by solder. The endcaps 18, 20 may be formed of an electrically conductive material, including, but not limited to, copper or one of its alloys, and may be plated with nickel or other conductive, corrosion resistant coatings. The fusible element 24 may be formed of an electrically conductive material, including, but not limited to, tin or copper, and may be configured to melt and separate upon the occurrence of a predetermined fault condition, such as an overcurrent condition in which an amount of current exceeding a predefined maximum value flows through the fusible element 24. This maximum value is commonly referred to as the “rating” of the fuse 10.

The fusible element 24 may be any type of fusible element suitable for a desired application, including, but not limited to, a wire, a corrugated strip, a wire wound about an insulating core, etc. The central portion 25 of the fusible element 24 may be thinned, narrowed, perforated, or otherwise weakened relative to other portions of the fusible element 24 to ensure that the fusible element 24 separates at the central portion 25. In various embodiments, a quantity of dissimilar metal 26 (hereinafter “the metal spot 26”), sometimes referred to as a “Metcalf spot,” may be applied to the central portion 25 of the fusible element 24. The metal spot 26 may be formed of one or more of nickel, indium, silver, tin, or other metal having a lower melting temperature than the base metal (e.g., copper) from which the fusible element 24 is formed. The metal spot 26 may therefore melt more readily than the base metal of the fusible element 24 upon the occurrence of an overcurrent condition and may diffuse into the base metal. The base metal of the fusible element 24 and the dissimilar metal of the metal spot 26 are chosen such that the diffusion of one into the other results in an intermetallic phase with a lower melting temperature and higher resistance than those of the base metal alone, which causes the central portion 25 of the fusible element 24 to melt more readily than other portions of the fusible element 24. In various embodiments of the fuse 10 the metal spot 26 may be entirely omitted.

The fuse 10 may further include arc barriers 30a, 30b disposed on the fusible element 24 on opposing sides of the central portion 25 along a length of the fusible element 24. Each of the arc barriers 30a, 30b may radially surround the fusible element 24 and may extend from the fusible element 24 to, or nearly to, an interior surface of the fuse body 12. The arc barriers 30a, 30b may be formed of a silicone composition formed of an arc quenching filler 32 suspended in a silicone resin 34. In various embodiments, the arc quenching filler 32 may be melamine powder. This present disclosure is not limited in this regard. In various alternative embodiments, the arc quenching filler 32 may include one or more of guanidine, guanine, hydantoin, allantoin, urea, melamine-formaldehyde, melamine-cyanurate polymer, boric acid, and derivatives or mixtures thereof, or other fillers that exhibit similar endothermic, arc quenching properties when burned as described below. The arc quenching filler 32 may be distributed substantially evenly throughout the silicone resin 34 and may account for approximately 5-70% by weight of the silicone composition.

Upon the occurrence of an overcurrent condition in the fuse 10, the central portion 25 of the fusible element 24 may melt and separate, and an electrical arc 36 may propagate across the gap left between the separated ends of the fusible element 24 as shown in FIG. 1B. Heat from the electrical arc may burn and decompose the silicone of the arc barriers 30a, 30b, which may contain the electrical arc 36 and the heat generated thereby. As the silicone decomposes, the arc quenching filler 32 in the arc barriers 30a, 30b may be exposed and may also be burned by the heat from the electrical arc 36. As the arc quenching filler 32 is burned and decomposes, it undergoes an endothermic chemical reaction that absorbs heat. The electrical arc 36 is thereby rapidly cooled. Furthermore, depending on the specific arc quenching filler 32 that is implemented in the arc barriers 30a, 30b (e.g., melamine), certain byproducts of the endothermic chemical reaction may be nonconductive gases (e.g., ammonia) that may hinder the ability of the electrical arc 36 to persist. Still further, other byproducts of the endothermic chemical reaction may produce water, which may further cool the electrical arc 36. Thus, the arc quenching filler 32 may, upon the occurrence of an electrical overcurrent condition in the fuse 10, absorb heat, release gases that are unfavorable to sustaining an electrical arc, and produce water which may further cool the electrical arc, all of which may contribute to rapid arc quenching. Components that are connected to the fuse 10 and/or that are located in the proximity of the fuse 10 are thereby protected from damage that might otherwise result if the electrical arc 36 were allowed to persist.

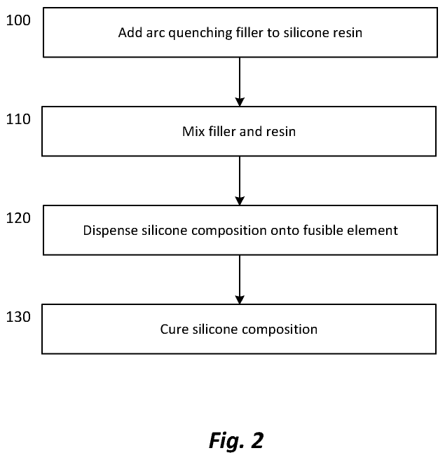

Referring to FIG. 2, a flow diagram illustrating an exemplary method for mixing and dispensing the silicone composition of the present disclosure is shown. The method will now be described in conjunction with the illustrations of the fuse 10 shown in FIGS. 1A and 1B.

At block 100 of the exemplary method, an arc quenching filler (e.g., melamine powder) may be added to a silicone resin in a liquid state. In various embodiments, the arc quenching filler may account for 5-70% by weight of the total mass of the silicone composition. The present disclosure is not limited in this regard. If melamine powder is used as the arc quenching filler, the size of the powder particles may be in a range of 5 um to 100 um in length or diameter. The present disclosure is not limited in this regard.

At block 110 of the exemplary method, the silicone and the arc quenching filler may be mixed together to create a homogenous or roughly homogenous silicone composition. At block 120 of the method, the silicone composition may be dispensed onto a fusible element. For example, referring to FIG. 1A, the silicone composition may be dispensed onto the fusible element 24 on opposing sides of the central portion 25 along a length of the fusible element 24.

At block 130 of the exemplary method, the dispended silicone composition may be cured or otherwise hardened to form the arc barriers 30a, 30b. In various examples, the silicone composition may be heat cured, humidity cured, UV cured, etc. The present disclosure is not limited in this regard.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A fuse comprising:
an electrically insulating, tubular fuse body;
electrically conductive first and second endcaps disposed over opposing ends of the fuse body;
a fusible element extending through the fuse body and connecting the first endcap to the second endcap, the fusible element having a central portion adapted to melt and separate upon an overcurrent condition in the fuse; and
first and second arc barriers disposed on the fusible element on opposing sides of the central portion, the first and second arc barriers formed of a silicone composition that includes an arc quenching filler suspended in a silicone resin.

2. The fuse of claim 1, wherein the arc quenching filler is one or more of melamine, guanidine, guanine, hydantoin, allantoin, urea, melamine-formaldehyde, melamine-cyanurate polymers, boric acid, and derivatives thereof.

3. The fuse of claim 2, wherein the arc quenching filler is melamine powder and a size of particles of the melamine powder is in a range of 5 um to 100 um in length or diameter.

4. The fuse of claim 1, wherein the arc quenching filler accounts for 5-70% by weight of a total mass of the silicone composition.

5. The fuse of claim 1, wherein the central portion of the fusible element is thinned, narrowed, perforated, or otherwise weakened relative to other portions of the fusible element to ensure that the fusible element separates at the central portion.

6. A method of producing and dispensing an arc quenching silicone composition, the method comprising:
adding an arc quenching filler to a silicone resin in a liquid state;
mixing the arc quenching filler and the silicone resin to create a homogeneous composition;
dispensing the composition onto a fusible element of a fuse; and
curing the composition.

7. The method of claim 6, wherein the arc quenching filler is one or more of melamine, guanidine, guanine, hydantoin, allantoin, urea, melamine-formaldehyde, melamine-cyanurate polymers, boric acid, and derivatives thereof.

8. The method of claim 7, wherein the arc quenching filler is melamine powder and a size of particles of the melamine powder is in a range of 5 um to 100 um in length or diameter.

9. The method of claim 6, wherein the arc quenching filler accounts for 5-70% by weight of a total mass of the silicone composition.

10. The method of claim 6, wherein dispensing the composition onto the fusible element comprises dispensing the composition onto the fusible element on opposite sides of a central portion of the fusible element, wherein the central portion is adapted to melt and separate upon an overcurrent condition in the fuse.

11. The method of claim 10, wherein the central portion of the fusible element is thinned, narrowed, perforated, or otherwise weakened relative to other portions of the fusible element to ensure that the fusible element separates at the central portion.
